(19) United States
(12) Patent Application Publication
(10) Pub. No.: US 2026/0100097 A1
(43) Pub. Date: Apr. 9, 2026

(54) RESPONSIBLE GAMING BILL VALIDATOR SYSTEM AND METHOD

(71) Applicant: idPair, Inc., Morristown, NJ (US)

(72) Inventor: Jonathan Christy Aiwazian, Morristown, NJ (US)

(21) Appl. No.: 19/352,050

(22) Filed: Oct. 7, 2025

Related U.S. Application Data
(60) Provisional application No. 63/705,414, filed on Oct. 9, 2024.

(51) Int. Cl. G07F 17/32

(52) U.S. Cl. CPC G07F 17/3244; G07F 17/3239

(57) ABSTRACT

A system and method for verifying a patron is eligible to play a gaming machine. A processor is operable to execute exclusion verification software. The process implemented by the exclusion verification software includes scanning an identification card of a patron, receiving identification scan data from the scanned identification card, and verifying the identification scan data as error free. A processor is operable to check an exclusion database for the verified identification scan data and determine an exclusion status of the patron based on a result of the check of the exclusion database. Based on the exclusion status of the patron, the processor is operable to send a signal to a bill validator either enabling or disabling the bill validator, log a verification attempt in data storage, and present a result of the verification on an output device, where the presentation indicates whether the gaming device is operable to be played.

### CROSS-REFERENCE TO RELATED APPLICATIONS

This application claims the benefit of U.S. Provisional Application No. 63/705,414, filed Oct. 9, 2024, which is incorporated herein by reference in its entirety.

### BACKGROUND

The presently disclosed subject matter can be used in gaming machines, vending machines and pay point machines, lottery machines and the like, where currency or bills are accepted for credit. For purposes of detailing the disclosed subject matter, however, an example gaming machine 10 as shown in FIG. 1 and FIG. 2, to which the disclosed subject matter may be applied is described in some detail.

The prior art gaming machine 10 generally includes a housing 14 of various potential configurations designed to contain the various components of such machines. The interior of the gaming machine 10 may normally be accessed through opening a front cover or door 16. Disposed within the housing 14 are the reels 18 for the play of the game, a central processing unit (CPU) 20 which controls the operation of the gaming machine 10, as well as a coin hopper assembly adapted to receive, hold, and dispense coins or tokens in a known fashion. As is known in the industry, the CPU 20 controls the operation of the gaming machine 10. To monitor the performance and operation, the CPU 20 of each gaming machine 10 in a facility may be in communication with a centralized system server (not shown). The system server monitors the revenue or amounts wagered, amounts paid out and the like for each gaming machine 10 in the facility.

To play a gaming machine 10, a patron inserts tokens, coins, bills, currency, or script, which are sensed and, if the inserted tokens, coins, bills, currency, or script are valid, are accumulated as credits for gaming. The inserted received coins or tokens are directed to the coin hopper assembly for storage, or the coins/tokens may be directed to an auxiliary collection location, for example under the machine. Alternatively, to amass credits for play of the gaming machine 10, the gaming machine 10 is provided with a bill acceptor 12 having a currency validator which receives notes as legal tender or script and, based upon the note's value, assigns a corresponding value of credits within the gaming machine 10 for gaming.

The bill acceptor 12, as shown in FIG. 2, includes a currency validator 26 adapted to scan a note inserted into a rectangular slot or opening 22 to determine the authenticity, type (legal tender or script, if required), denomination and condition (whether the note is worn) of the note. The enhanced bezel 24 is preferably placed on the front of the bill acceptor 12 and below the opening 22. The enhanced bezel 24 is used as a mechanical interface to the game machine door 16, as it projects to or through an opening in the door 16. The enhanced bezel 24 provides a runway surface 34 before the opening 22 to allow the patron to easily insert the note into the bill acceptor 12. The enhanced bezel 24 includes a display surface 36 vertically mounted at the leading edge of the runway surface 34.

A note, once inserted over the runway surface 34 and into opening 22, is captured and transported by a transportation unit 30 past optical and magnetic sensors (not shown). Upon receipt and determination of validity, a signal is sent to the gaming machine's CPU 20 signifying receipt as well as the denomination of the note for accumulation of a like value amount of credits in the gaming machine 10. If the note is not validated, the transportation unit 30 is reversed and the note is ejected through the opening 22 to the customer.

The information accumulated by the validator processor, such as the status of the bill acceptor and denomination of accepted notes, is available to be communicated to and displayed on the indicators on the runway surface 34 and/or display surface 36 of the enhanced bezel 24. The display indicators on the enhanced bezel 24 may be controlled directly by a processor that uses the results to control the visual display indicators.

The gaming industry has grown significantly in recent years, with the rise of casinos in multiple states, online gaming, and lottery systems. However, this growth has also led to an increase in problem gambling, with many individuals struggling with addiction and financial difficulties. To address this issue, regulatory bodies have implemented self-exclusion programs, allowing individuals to voluntarily exclude themselves from gaming activities for a specified period. However, existing self-exclusion systems rely on manual identification and verification processes, which can be costly, time-consuming, prone to errors, and vulnerable to exploitation. Additionally, no such verification currently exists on or, in proximity to, physical gaming machines.

As a result, what is needed is an exclusion verification system (EVS) that disables gaming devices based on the individual attempting to play the gaming machine thereby enabling individuals that wish to cease gaming for a period of time to do so. Alternatively, or in addition, other embodiments of an EVS enable gaming entities to prevent undesirable players or underage players from using the gaming machines.

### BRIEF SUMMARY

In one aspect, a method for verifying that a patron is eligible to play a gaming machine includes scanning an identification card of a patron is disclosed. A processor receives identification scan data from the scanned identification card and verifies the identification scan data as error free. An exclusion database is checked by the processor for the verified identification scan data, and the processor determines an exclusion status of the patron based on a result of the check of the exclusion database. Based on the exclusion status of the patron, the processor sends a signal to a bill validator either enabling or disabling the bill validator. The processor may log a verification attempt in data storage. A result of the verification is presented on an output device, where the presentation indicates whether the gaming device is operable to be played.

In another aspect, a gaming machine patron verification system is disclosed. The gaming machine patron verification system includes a verification device and a gaming machine. The verification device may include a memory storing exclusion verification software, identification scan data, and an exclusion database, and a processor coupled to the memory. The processor may be operable to execute the exclusion verification software stored in the memory. The communication interface is coupled to the processor. The verification device also includes an identification card reader operable to obtain identification scan data by scanning an identification card. The verification device also includes a bill validator operable to be controlled to receive and authenticate receipt of payment. The processor is operable to receive the identification scan data from the scanned identification card, confirm the identification scan data as error free, check the exclusion database for the verified identification scan data, determine an exclusion status of the person based on a result of the checking of the exclusion database, based on the exclusion status of the persons, send a signal to a bill validator either enabling or disabling the bill validator, log a verification attempt in a data storage, and cause presentation of a result of the verification on an output device.

### BRIEF DESCRIPTION OF THE DRAWINGS

To easily identify the discussion of any particular element or act, the most significant digit or digits in a reference number refer to the figure number in which that element is first introduced.

FIG. 1 illustrates an example of a prior art gaming device.

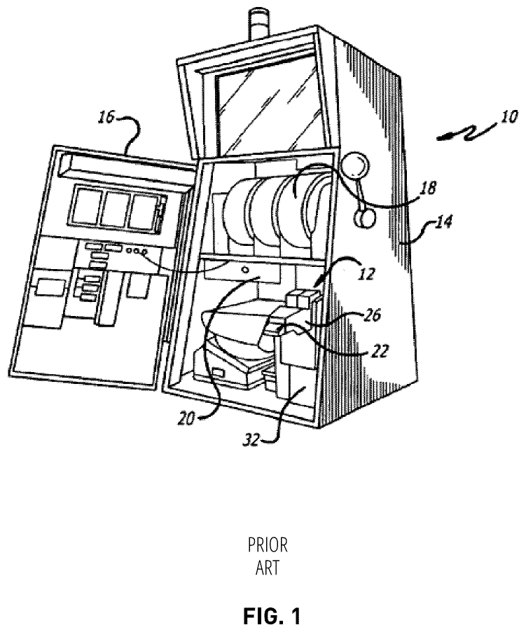

FIG. 2 illustrates an example of a prior art bill validator used with the prior art gaming device of FIG. 1.

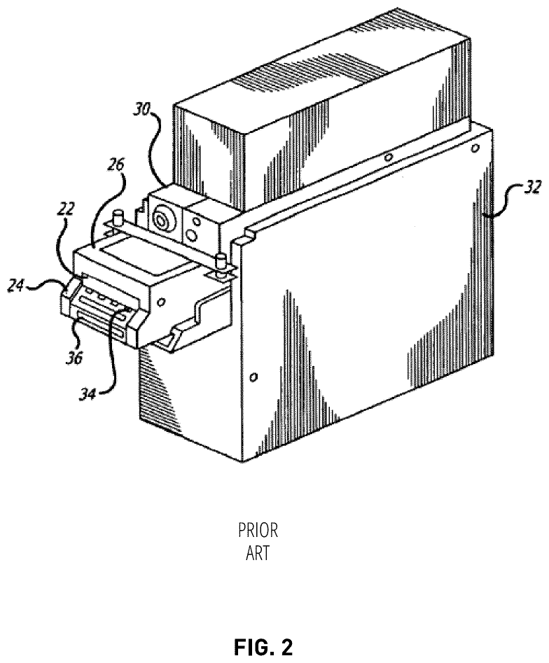

FIG. 3 illustrates a patron exclusion verification process in accordance with an embodiment of the disclosed subject matter.

FIG. 4 illustrates a block diagram of an example of a gaming machine patron verification system according to the disclosed subject matter.

FIG. 5 illustrates a block diagram of another example of a gaming machine patron verification system according to the disclosed subject matter.

### DETAILED DESCRIPTION

The following describes exclusion verification software (EVS) designed to be integrated into, or communicatively coupled to, a bill validator device to provide a secure and reliable exclusion verification process for gaming machines. Its intended use is to 1) Prevent self-excluded individuals from using gaming machines; 2) Support responsible gaming initiatives by providing an additional layer of control; and 3) Ensure compliance with regulatory requirements for self-exclusion programs. However, other uses are envisioned such as verifying the age of a patron, and identifying banned patrons (e.g., patrons known to be indebt, cheaters, unruly, a nuisance, or the like).

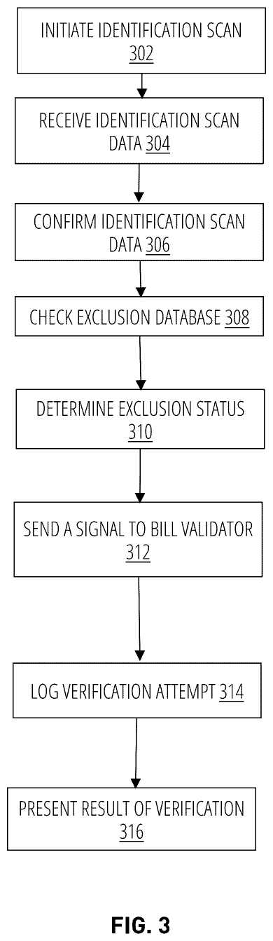

FIG. 3 illustrates a patron exclusion verification process in accordance with an embodiment of the disclosed subject matter.

FIG. 3 illustrates an example process 300 for verifying a patron is permitted to play the gaming machine. A “Patron” refers to a person attempting to play a gaming machine. Although the example process 300 depicts a particular sequence of operations, the sequence may be altered without departing from the scope of the present disclosure. For example, some of the operations depicted may be performed in parallel or in a different sequence that does not materially affect the function of the process 300. In other examples, different components of an example device or system that implements the process 300 may perform functions at substantially the same time or in a specific sequence.

According to some examples, the process 300 includes an initiation of an identification scan at 302. For example, step 302 may begin with receiving an identification card of the patron wishing to play a gaming machine. The identification card is received in an optical scanning device and/or a magnetic scanning device configured to read data from identification cards. The optical scanning device and/or the magnetic scanning device may be operable to obtain identification scan data from the identification card and forward the identification scan data to a processor for verification.

The processor may be operable to receive identification scan data 304 and execute the exclusion verification software that includes confirming identification data at 306. The processor when confirming the identification data at 306, may be operable to confirm the identification scan data as error free. Examples of error free data may include data that has a correct format for the entity that issued the identification card. For example, a Massachusetts'identification card, such as a driver's license, may have a particular format for presenting the birthdate, driver's license number, name order, or the like, which is different from driver's licenses issued by other States such as Maryland, or other entities. Examples of identification cards from other entities may be university/student identifications, State or Government Agency identification cards, gaming entity/operator cards (e.g., loyalty cards, affinity cards, reward cards, etc.), or the like. Further examples of identification cards may include passports, gaming entity/operator issued identification cards (including loyalty, affinity, and/or rewards cards), or the like that may be used to identify the person. In addition, the user when enrolling in a self-exclusion program may list the identification cards that they would present. It is also envisioned that biometric identification may replace or be used in combination with identification cards. For example, biometric identifiers, such as faceprints, fingerprints, voice signatures, or combinations thereof may be used in place of, or to augment, identification cards, and the ID card readers described herein may be modified with cameras, microphones, touchscreens, and related software to facilitate capture of the biometric identifier.

An exemplary process to confirm that the identification scan data is error free may include obtaining from the identification scan data an entity that issued the identification card of the patron. The format of the identification scan data may be compared to an identification scan data format for the entity that issued the identification card of the patron. The processor, in response to a result of the comparison indicating no discrepancies, may be operable to generate a signal indicating the identification scan data is error free, and the process 300 may proceed to 308 by forwarding verified identification scan data (i.e., identification scan data that is verified to be error free). However, if the response to the result of the comparison indicates discrepancies, the processor may generate a signal indicating the identification scan data, also referred to as “ID scan data,” has an error or errors, and return to step 302. In a further example, the processor in response to the identification scan data having errors may be operable to cause a prompt to be presented on an output device for the patron to try again or use another form of identification.

At 308, according to some examples, the process 300 includes a check of an exclusion database. For example, a processor executing the exclusion verification software may be configured to check the identification scan data against an exclusion database (local) or the exclusion database (external) (shown in a later example). The check of the exclusion database may include the processor accessing the exclusion database to determine whether a portion of the identification scan data is present in the exclusion database. Whether the processor accesses with a local exclusion database or an external exclusion database may depend on the type of gaming entity. For example, a gaming machine, such as a lottery machine in a grocery store, may be operable to access an external exclusion database, while a slot machine in a casino may be operable to access a local exclusion database. The assumption being, in the example, that the casino has a larger computer infrastructure that can receive frequent updates of a self-exclusion program and/or banned patrons, and the grocery store has access to data communication networks. But either type of exclusion database (i.e., local, or external), or both, may be accessed and used to evaluate the ID scan data.

At 310, the processor may determine a player's exclusion status. For example, when determining the exclusion status of the patron based on the result of the check of the exclusion database, the processor may execute a number of steps. For example, in response to a portion, or all, of the identification scan data being present in the exclusion database, the processor may be operable to identify a status of the patron using the identification scan data. For example, the exclusion database may have a status flag set to indicate that the status of the patron is either permitted to or excluded from playing the gaming machine. In an example, if a patron's ID scan data does not appear in the exclusion database(s), the patron's exclusion status is set as “permitted“ or ”permitted to play.” Based on the result of the determination of the player's exclusion status, the processor executing process 300 may be operable to send a signal to a bill validator at 312. For example, in response to the determination of the exclusion status of the patron indicating the patron is permitted to play, the processor may generate an accept currency signal as the signal to be sent to the bill validator. The accept currency signal enables the bill validator to receive currency. In an example, the accept currency signal may enable the bill validator to receive currency for a limited period of time, such as 30 seconds, 45 seconds, 1 minute, or the like. Alternatively, or additionally, the bill validator may be enabled to receive currency until a reject currency signal is received. Alternatively, in response to the determination of the exclusion status of the patron indicating the patron is ineligible to play (i.e., excluded), the processor may generate a reject currency signal as the signal to be sent to the bill validator, wherein the reject currency signal disables the bill validator to receive currency. Additionally, the processor may be operable to notify the operator of the establishment, gaming entity, and/or a regulator of the attempt to play by a self-excluded individual or excluded individual.

According to some examples, the process 300 includes a log verification attempt at 314. For example, when logging a verification attempt in a data storage, the processor, in response to the determination of the exclusion status of the patron indicating the patron is ineligible to play, may store the identification scan data in a verification database as a verification attempt of the patron indicated as ineligible to play. In some jurisdictions, privacy may be a concern and as such the exclusion verification software may implement an anonymization algorithm to strip or mask (e.g., by using a proprietary hashing function or the like) the Personally Identifiable Information, without removing the ability to screen the exclusion database and update the verification database. The verification database may be a row or column in, or part of, the exclusion database to enable the gaming entity to provide evidence of adhering to a self-exclusion program.

In addition, in response to the determination of the exclusion status of the patron that indicates the patron is permitted to play, the processor may be operable to increase a count of a number of verification attempts made for the gaming machine to illustrate how many patrons used a particular gaming machine, keep track of the number of times a particular scanner was used for maintenance purposes, or the like.

At 316, the processor may be operable to present a result of the verification. For example, in response to an accept currency signal, the presentation generated by the processor indicates the bill validator is enabled to receive currency. For example, the bill validator may be configured with indicator lights, such as green or the like, a display device, an audio output device, or the like, so the patron knows that they are permitted to play the gaming machine.

Conversely, in response to an excluded patron signal, the presentation indicates the bill validator is disabled to receive currency. In this case, the indicator lights may be red, orange or the like, and messages on the display device or generated by the audio output device may indicate the patron is ineligible to play the gaming machine.

The foregoing description of process 300 is an example of a process that may be implemented to accomplish the intended and other uses of the disclosed subject matter. Of course, fewer steps may be used and/or several steps may be combined.

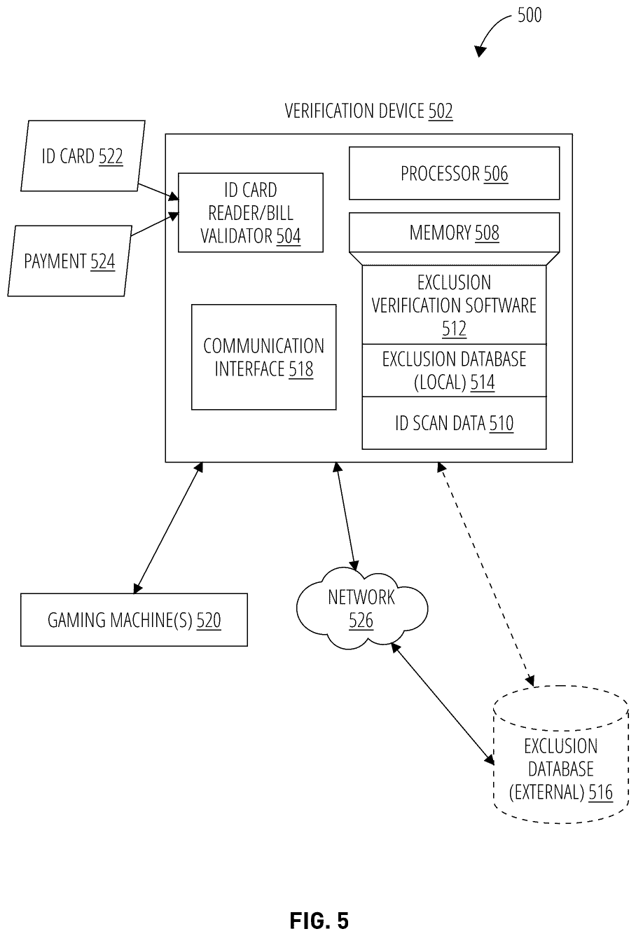

The example gaming machine patron verification system may have features, such as a default setting and multiple configurations for the location of the ID card reader, and control of currency validation. For example, a default setting may include a setting where the system does not accept currency until identity verification and an exclusion check are completed. In addition, it is envisioned that the ID card reader may be configured to be integrated into the bill validator (e.g., positioned in the same slot as the currency acceptor, which is described with reference to FIG. 5 below), or in other examples, the ID card reader is located on the gambling machine, externally via a mobile device application, or on a separate machine in the gaming facility. This may be implemented, for example, using a website or a mobile device application. In an example, in order to engage the bill validator to accept currency, a website or app is opened, the patron enters a slot machine number and performs a Know Your Customer (KYC)-like process where the patron is validated, and the result is sent to the slot machine to allow the bill validator to accept payment. Similarly, for an external device, such as a gaming machine at the grocery store, a process, such as the CLEAR® process at an airport, may be used, and the resulting KYC is sent the gaming machine.

In yet another example, it is envisioned that the exclusion verification software is operable to set the whole gaming machine to be inactive (including the bill validator) until an ID is validated. The gaming machine patron verification system disclosed herein aims to enhance responsible gambling practices by ensuring that individuals who have self-excluded from gambling in a particular jurisdiction cannot use electronic gambling machines. By integrating identity verification and (self-)exclusion checks into the bill validation process, this system provides an additional layer of control and support for responsible gaming initiatives.

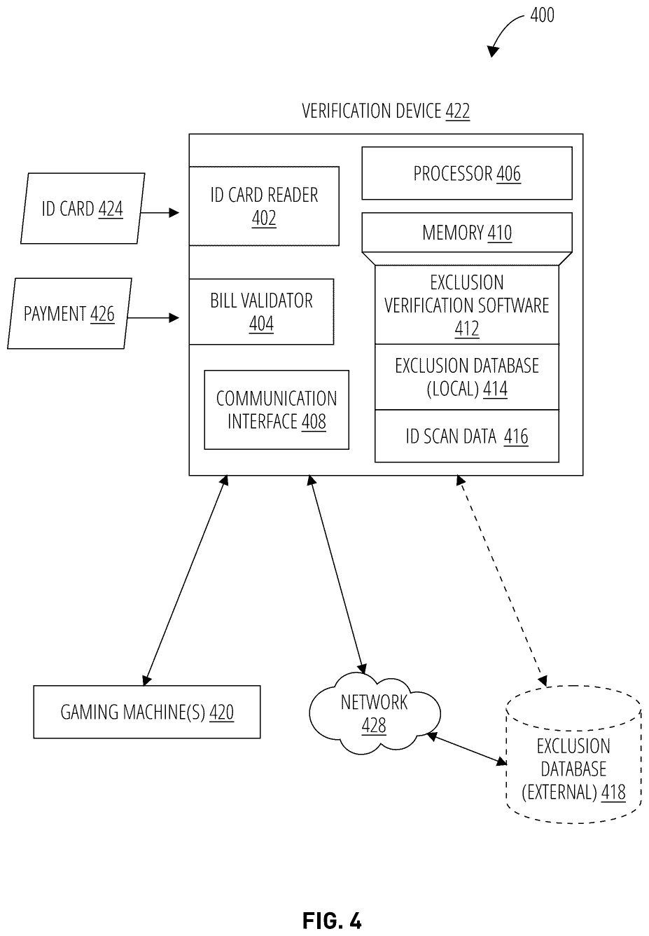

FIG. 4 illustrates a block diagram example of a gaming machine patron verification system according to the disclosed subject matter. In an example, the gaming machine patron verification system 400 includes a verification device 422 and a gaming machine(s) 420.

The verification device 422 may include an ID card reader 402, a bill validator 404, a processor 406, communication interface 408, and a memory 410. The processor 406 is communicatively coupled to each of the ID card reader 402, the bill validator 404, the communication interface 408, and the memory 410. The memory 410 may be operable to store exclusion verification software 412, an exclusion database (local) 414, ID scan data 416, and the like. The gaming machine(s) 420 may be any type of gaming machine such as those described with reference to the earlier examples.

The ID card reader 402 is a hardware device that includes an optical scanner, a magnetic card reader, and/or the like. The data scanned by the ID card reader 402 from a presented identification card may be optical or magnetic data that provides identifying data from the presented identification card. The ID scan data may include extracted relevant information such as, for example, name, date of birth, entity issuing the identification card, and ID number (e.g., driver's license number, state identification number, student identification number, or the like). In another example, only minimal data may be extracted, such as the ID number and the entity issuing the identification card.

The ID card reader 402 may be operable to accept identification cards 424, such as driver's licenses, state identification cards, and other government-issued identifications. The orientation of the inserted identification card may be face-up or face-down. In an example, the ID card reader 402 is operable to allow the insertion or swiping of an identity card (e.g., driver's license) to verify the user's identity. The processor 406 is operable to check the ID scan data against exclusion lists stored in an exclusion database, for example, in the jurisdiction where the machine is located. These exclusion databases may also be referred to as exclusion database (local) 414. Alternatively, or in addition, the processor 406 may be operable to check the ID scan data against an external exclusion database, such as exclusion database (external) 418, that covers a wider range of jurisdictions. Periodic updates of the exclusion list(s) may be delivered to the verification device 422 via a remote transfer from network 428 or the external exclusion database 418 at a regular update frequency, where the update frequency may vary in length from one jurisdiction to another.

In the embodiment shown in FIG. 4, the ID card reader 402 of the verification device 422 may be located adjacent to the bill validator 404 and provide in a separate entry point for the ID card 424. In an example where the ID card reader 402 is external to verification device 422 and not co-located with the bill validator 404, the ID card reader 402 may have any dimensions but needs to be within communication range of the verification device 422 to communicate with the bill validator 404 to accept currency if a player's exclusion status is “permitted to play.” The bill validator 404 is configured to accept payment 426 at a location different from where the ID card 424 is inserted or swiped. The payment 426 may be US currency denominations: $1, $5, $10, $20, $50, $100, but may also be configured to accept any international currency or scripts, or some electronic forms of payment. If the bill validator 404 is configured to accept credit cards or other forms of payment, this payment method may also be deactivated before the payment 426 is accepted.

In an example, the bill validator 404 is designed for use in electronic gaming machines including, but not limited to, slot machines, video lottery terminals (VLTs), video gaming terminals (VGTs), video slots, and vending machines that dispense gambling, gaming, and lottery items.

The bill validator 404 is configured to revert back to not accepting currency after a period of 30-60 seconds, for example, after it has not received further deposits to limit access for individuals who sit down immediately after the current patron leaves the gaming machine). In an example, the 30-60 second period may be modified to permit sufficient time to allow for the current game being played to conclude. It is anticipated that no structural change to the bill validator 404 externally, but internally there will be components that respond to signals from the processor based on the exclusion status of the presented ID for self-exclusion before enabling detection of currency. For example, there may also be an indicator light that changes red or green based on the result of the ID scan and exclusion database check.

The exclusion verification software 412 (EVS) is operable to cause the processor 406 to access exclusion lists via Wi-Fi or Ethernet or a database loaded directly onto device via an update that may occur daily or weekly. The EVS software is responsible for receiving ID scan data, verifying the user's identity, and checking against a self-exclusion database (and age) to determine whether the individual is eligible to use the gaming machine. The software communicates with the bill validator to control currency acceptance based on the verification result.

In an example, the exclusion verification software 412 may be operable to manage the exclusion database (local) 414. For example, the exclusion verification software 412 may cause the processor to load the exclusion database (local) 414 onto the device itself (local storage). Alternatively, as mentioned in the discussion of FIG. 3, the exclusion verification software 412 may cause the processor 406 to access an exclusion database (external) 418, which may be cloud-based or server-based) to check for exclusion status of the patron being verified.

In a further example, the gaming machine patron verification system 400 may also include an exclusion database (external) 418 that is accessible by the processor 406 via the communication interface 408. In yet a further example, the exclusion database (external) 418 may be coupled to a network 428 that is accessible to the processor 406 via the communication interface 408.

Based on the ID scan data, the exclusion verification software 412 may include a verification algorithm that is operable to cause the processor to match the ID scan data against the exclusion database (local) 414 or exclusion database (external) 418, ensuring accurate and reliable results.

In addition, the processor 406 is operable to Communication with the bill validator 404. For example, the processor 406 is operable to send via the communication interface 408 a signal to the bill validator to control currency acceptance based on the verification result: 1) if the individual is not excluded, sends a “accept currency” signal; and 2) if the individual is excluded, sends a “reject currency” signal.

In some examples, the processor 406 is operable to perform logging and reporting. For example, the processor 406 may be operable to maintain a log of verification attempts, including the number, the date, the time, ID scan data, and/or verification results, for auditing and reporting purposes. In an example, the processor 406 may be operable to in response to the determination of the exclusion status of the patron indicating the patron is permitted to play, increase a count of a number of verification attempts made for the gaming machine. The processor 406, in a further example, may be operable to store the date, the time, and/or portions of the ID scan data, in addition to the total number of verification attempts.

Security and Encryption: Implements robust security measures, including data encryption and secure communication protocols, to protect sensitive information.

The communication interface 408 may function according to one or more communication protocols, such as USB, RS-232, or TCP/IP. The integration with the gaming machine(s) 420 may be compatible with industry-standard gaming machines.

In an operational example, the ID card reader 402 scans the user's ID card and sends the data to the bill validator 404 The bill validator 404 receives the ID scan data and sends it to the processor 406. The processor 406 processes the ID scan data using the exclusion verification software 412. The processor 406 executing the exclusion verification software 412 checks the ID scan data against the exclusion database (local) 414 or the exclusion database (external) 418. Based on the verification result, exclusion verification software 412 causes the processor 406 to send a signal to the bill validator 404 to accept or reject currency. According to the signal, the bill validator 404 accepts or rejects currency accordingly. The communication interface 408 enables communication between the system and external systems (e.g., gaming machines), for example, via the network 428. The network 428 may be a Wi-Fi network, Ethernet, local area network, wide area network, cellular network, or the like, or a combination thereof.

This exemplary block diagram illustrates the main components and relationships. Additional components or variations and other relationships may be included depending on specific requirements or implementation details.

FIG. 5 illustrates a block diagram of another example of a gaming machine patron verification system according to the disclosed subject matter.

The gaming machine patron verification system 500 is substantially similar to that of the gaming machine patron verification system 400 described with reference to FIG. 4. However, the

The invention is a novel bill validator device designed for use in electronic gambling machines, including slot machines, video lottery terminals (VLTs), video gaming terminals (VGTs), video slots, and vending machines that dispense gambling items. In this example, the gaming machine patron verification system 500 utilizes a device that integrates two key functions: exclusion check and currency validation, which is different from the gaming machine patron verification system 400.

In the gaming machine patron verification system 500, The gaming machine patron verification system 500 includes a verification device 502, and a gaming machine(s) 520. The verification device 502 includes an ID card reader/bill validator 504, a processor 506, a communication interface 518, a memory 508, and a network 526. The memory 508 may include data storage for ID scan data 510, exclusion verification software 512 for execution by the processor 506, an exclusion database (local) 514 accessible by the processor 506, and the like.

The verification device 502 may also be communicatively coupled to a network 526 and an exclusion database (external) 516 via the communication interface 518. In one example, the communication interface 518 may be configured to communicate directly with the exclusion database (external) 516. In another example, the communication interface 518 may be configured to communicate via the network 526 with the exclusion database (external) 516.

The exemplary ID card reader/bill validator 504 is configured to integrate two key functions: identity verification and currency validation.

The ID card reader/bill validator 504 is a hardware device that includes an optical scanner, a magnetic card reader, and/or the like operable to scan both ID Cards 522 and payment 524. The data scanned by the ID card reader/bill validator 504 is from a presented identification card 522 and may be optical or magnetic data that provides identifying data from the presented identification card 522. In addition, the ID card reader/bill validator 504 is configured to accept currency, script, credit/debit cards, electronic payment, such as bitcoin, Apple Pay®, or the like (i.e., payment 524). For example, US currency denominations: $1, $5, $10, $20, $50, $100, may be accepted but may also be configured to accept any international currency or scripts. In addition, the ID card reader/bill validator 504 may be configured to accept credit card or other forms of payment. Of course, this payment method may also be deactivated until the patron is identified as a permitted player.

In the disclosed example, a patron may first insert their ID Card 522, and upon verification that the patron is permitted to play the gaming machine, the ID card reader/bill validator 504 may be enabled to accept a payment 524. The process for enabling the ID card reader/bill validator 504 to accept the payment 524 is substantially the same as described above with reference to the process 300 of FIG. 3 and functions of similar devices, such as verification device 422 of FIG. 4. Therefore, no further discussion is provided.

The ID card reader/bill validator 504 may have physical features that enable the acceptance of an ID Card 522 and currency. In an example, the ID card reader/bill validator 504 may be configured to only provide an opening that fits the dimensions of an ID card, and once scanned, a level expands to enable insertion of currency, for example, by mechanically opening up to the size of a dollar bill or other form of payment (e.g., credit/debit card), to thereby accept payment by currency or the like. In an example, a level may be a part of the ID card reader/bill validator 504 that is above, below, or part of the opening that fits the dimensions of the ID card that is operable to mechanically open or expand to permit insertion of currency, credit/debt cards, payment cards, affinity cards, or the like based on processor signals to electromechanical components of the ID card reader/bill validator 504. Alternatively, the ID card reader/bill validator 504 may be configured with an ID insertion slot above, below, or adjacent to an opening where the currency is inserted.

The exclusion verification software 512 is operable to cause the processor 506 to access exclusion lists via Wi-Fi or Ethernet or a database loaded directly onto device via an update that may occur daily or weekly. The processor 506 executing exclusion verification software 512 controls, for example, receiving ID scan data, verifying the user's exclusion status, and checking against a self-exclusion database (and age) to determine whether the individual is eligible to use the gaming machine. The exclusion verification software 512 communicates with the bill validator to control currency acceptance based on the verification result.

The communication interface 518 may function according to one or more communication protocols, such as USB, RS-232, or TCP/IP. The integration with the gaming machine(s) 520 may be compatible with industry-standard gaming machines.

In an operational example, the ID card reader/bill validator 504 scans the user's ID card and sends the data to the processor 506. The processor 506 processes the ID scan data using the exclusion verification software 512. The processor 506 executing the exclusion verification software 512 checks the ID scan data against the exclusion database (local) 514 or the exclusion database (external) 516. Based on the verification result, exclusion verification software 512 causes the processor 506 to send a signal to the ID card reader/bill validator 504 to either accept or reject currency.

The disclosed Exclusion Verification System (EVS), offers several advantages over existing solutions:
1. Improved Accuracy: EVS uses advanced ID scanning and verification technology to ensure accurate identification and verification of individuals, reducing errors and false positives.
2. Increased Efficiency: EVS automates the self-exclusion verification process, streamlining the identification and verification steps, and reducing the time required to verify an individual's self-exclusion status.
3. Enhanced Security: EVS uses secure communication protocols and encryption to protect sensitive information, ensuring the integrity of the self-exclusion database and preventing unauthorized access.
4. Real-time Verification: EVS enables real-time verification of self-exclusion status, ensuring that individuals who have self-excluded are prevented from gaming immediately.
5. Scalability: EVS can be easily integrated into existing gaming systems and can handle a large volume of transactions, making it an ideal solution for large-scale gaming operations.
6. Compliance: EVS helps gaming operators comply with regulatory requirements for self-exclusion programs, reducing the risk of non-compliance and associated penalties.
7. User-Friendly: EVS provides a user-friendly interface for individuals to self-exclude, making it easier for them to take control of their gaming activities.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Indeed, the terms “processor,” “controller,” and the like, are generally used interchangeably herein, and refer to any of the above devices and systems, as well as any data processor.

While this specification contains many specific implementation details, these should not be construed as limitations on the scope of any disclosed subject matters or of what may be claimed, but rather as descriptions of features specific to particular implementations of particular disclosed subject matters. Certain features that are described in this specification in the context of separate implementations may also be implemented in combination in a single implementation. Conversely, various features that are described in the context of a single implementation may also be implemented in multiple implementations separately or in any suitable sub combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations. Furthermore, it should be understood that the described program components and systems may, optionally, be integrated together in a single software product or packaged into multiple software products.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips, FPGAs), nanotechnology memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code or programming code, or software and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for verifying a patron is eligible to play a gaming machine, comprising:
scanning an identification card of a patron;
receiving identification scan data from the scanned identification card;
confirming the identification scan data as error free;
checking an exclusion database for the error-free identification scan data;
determining an exclusion status of the patron based on a result of the checking of the exclusion database;
based on the exclusion status of the patron, sending a signal to a bill validator either enabling or disabling the bill validator;
logging a verification attempt in a data storage; and
causing presentation of a result of the verification on an output device.

2. The method of claim 1, further comprising:
in response to the determination of the exclusion status of the patron indicating the patron is permitted to play, generating an accept currency signal as the signal to be sent to the bill validator, wherein the accept currency signal enables the bill validator to receive currency.

3. The method of claim 2, further comprising:
indicating via the presentation by the output device, the bill validator is enabled to receive currency.

4. The method of claim 1, further comprising:
in response to the determination of the exclusion status of the patron indicating the patron is ineligible to play, generating a reject currency signal as the signal to be sent to the bill validator, wherein the reject currency signal disables the bill validator to receive currency.

5. The method of claim 4, further comprising:
indicating, via the presentation by the output device, the bill validator is disabled to receive currency.

6. The method of claim 1, wherein scanning an identification card, comprises:
receiving the identification card in an optical scanning device and/or a magnetic scanning device;
obtain identification scan data from the optical scanning device and/or the magnetic scanning device; and
forwarding the identification scan data to a processor for verification.

7. The method of claim 1, wherein confirming the identification scan data as error free, comprises:
obtaining from the identification data an entity that issued the identification card of the patron;
comparing a format of the identification scan data to an identification scan data format for the entity that issued the identification card of the patron;
in response to a result of the comparison indicating no discrepancies, generating a signal indicating the identification scan data is error free.

8. The method of claim 1, wherein determining the exclusion status of the patron based on the result of the check of the exclusion database, comprising:
accessing the exclusion database to determine whether a portion of the identification scan data is present in the exclusion database;
in response to the portion of the identification scan data being present in the exclusion database, identifying a status of the patron using the identification scan data, wherein the status of the patron is either permitted or unpermitted.

9. The method of claim 1, wherein logging a verification attempt in a data storage, further comprises:
in response to the determination of the exclusion status of the patron indicating the patron is ineligible to play, storing the identification scan data in a database as a verification attempt of the patron indicated as ineligible to play.

10. The method of claim 1, wherein logging a verification attempt in a data storage, further comprises:
in response to the determination of the exclusion status of the patron indicating the patron is permitted to play, increasing a count of a number of verification attempts made for the gaming machine.

11. A gaming machine patron verification system, further comprising:
a verification device including:
a memory storing exclusion verification software, identification scan data, and an exclusion database,
a processor coupled to the memory, wherein the processor is operable to execute the exclusion verification software stored in the memory, and
a communication interface coupled to the processor;
an identification card reader operable to obtain identification scan data by scanning an identification card; and
a bill validator operable to be controlled to receive and authenticate receipt of payment, wherein the processor is operable to:
receive the identification scan data from the scanned identification card;
confirm the identification scan data as error free;
check the exclusion database for the verified identification scan data;
determine an exclusion status of the person based on a result of the checking of the exclusion database;
based on the exclusion status of the persons, send a signal to a bill validator either enabling or disabling the bill validator;
log a verification attempt in a data storage; and
cause presentation of a result of the verification on an output device.

12. The gaming machine patron verification system of claim 11, wherein the verification device is integrated in the bill validator.

13. The gaming machine patron verification system of claim 12, wherein the identification card reader and the bill validator are combined in a single device.

14. The gaming machine patron verification system of claim 11, wherein the processor is further operable to:
in response to the determination of the exclusion status of the patron indicating the patron is permitted to play, generate an accept currency signal as the signal to be sent to the bill validator, wherein the accept currency signal enables the bill validator to receive currency.

15. The gaming machine patron verification system of claim 14, wherein the bill validator comprises:
an output device, and
the bill validator is further operable to:
in response to the accept currency signal, present, via the output device, an indication the bill validator is enabled to receive currency.

16. The gaming machine patron verification system of claim 11, further comprising:
in response to the determination of the exclusion status of the patron indicating the patron is ineligible to play, generating a reject currency signal as the signal to be sent to the bill validator, wherein the reject currency signal disables the bill validator to receive currency.

17. The gaming machine patron verification system of claim 16, wherein the bill validator comprises:
an output device, and
the bill validator is further operable to:
in response to the reject currency signal, present, via the output device, an indication the bill validator is disabled to receive currency.

18. The gaming machine patron verification system of claim 11, wherein the identification card reader is further operable, when scanning the identification card, to:
receive the identification card in an optical scanning device and/or a magnetic scanning device;
obtain identification scan data from the optical scanning device and/or the magnetic scanning device; and
forward the identification scan data to the processor for verification.

19. The gaming machine patron verification system of claim 11, wherein the processor, when confirming the identification scan data as error free, is further operable to:
obtain from the identification data an entity that issued the identification card of the patron;
compare a format of the identification scan data to an identification scan data format for the entity that issued the identification card of the patron;
in response to a result of the comparison indicating no discrepancies, generate a signal indicating the identification scan data is error free.

20. The gaming machine patron verification system of claim 11, wherein the processor, when determining the exclusion status of the patron based on the result of the check of the exclusion database, is further operable to:
access the exclusion database to determine whether a portion of the identification scan data is present in the exclusion database; and
in response to the portion of the identification scan data being present in the exclusion database, identify a status of the patron using the identification scan data, wherein the status of the patron is either permitted or unpermitted.

21. The gaming machine patron verification system of claim 11, wherein the processor, when logging a verification attempt in a data storage, is further operable to:
in response to the determination of the exclusion status of the patron indicating the patron is ineligible to play, store the identification scan data in a database as a verification attempt of the patron indicated as ineligible to play.

22. The gaming machine patron verification system of claim 11, wherein the processor, when logging a verification attempt in a data storage, is further operable to:
in response to the determination of the exclusion status of the patron indicating the patron is permitted to play, increase a count of a number of verification attempts made for the gaming machine.

23. The gaming machine patron verification system of claim 11, wherein the processor is further operable to:
in response to the enabling the bill validator to receive currency, cause the bill validator to modify a level by mechanically expanding to accept payment.
